(19) United States
(12) Patent Application Publication
(10) Pub. No.: US 2017/0212082 A1
(43) Pub. Date: Jul. 27, 2017

(54) ULTRASONIC FITTINGS

(71) Applicant: Introtek International, Edgewood, NY (US)

(72) Inventor: Joseph Mariano, Elmont, NY (US)

(21) Appl. No.: 15/003,528

(22) Filed: Jan. 21, 2016

(51) Int. Cl. G01N 29/024

(52) U.S. Cl. CPC G01N 29/024; G01N 2291/011

(57) ABSTRACT

The present technology is directed to the integration of a fixed ultrasonic device into a connector fitting adapted to connect fluid conduits, as well as methods of detecting the presence or absence of media passing through a fitting.

### TECHNICAL FIELD

The present technology relates generally to apparatuses and methods for detecting air and liquid in a fitting.

### BACKGROUND

When using piping, tubing or other fluid handling hardware, it can often be difficult to positively determine the internal air or liquid. It is often important, and sometimes crucial, to identify air or other gases within a fluid conduit. Visual inspection is sometimes not possible or adequate to determine this. This applies to numerous types of apparatus such as, for example, analytical instrumentation used in laboratories, medical equipment, chemical and refining plants and the like, which require connection of a first conduit through which is transported a fluid, such as a liquid or gas, to a second conduit.

Many of these fluid handling systems utilize one or more connectors operatively interposed in the gas or liquid stream. These connectors act as a means of making a union between conduits used to transport the fluid.

Ultrasound is sound at frequencies greater than 20 kHz. Ultrasonic devices produce ultrasonic waves that can be continuous or pulsed. These devices do not require contact with the sample it is testing and are typically non-destructive. Commonly used frequencies are between 20 kHz to 20 MHz, or 20 kHz to 10 MHz, or 500 kHz to 4 MHz, or 1 MHz to 3 Mhz.

A need exists for apparatuses and methods that can accurately identify air or other gases within a fluid conduit.

### SUMMARY

In certain embodiments, the present technology is directed to the integration of a fixed ultrasonic device into a connector fitting adapted to connect fluid conduits. The technology includes many types of connectors including, for example, screw-on, snap-on, glued, adhered, soldered, ferrules, valves, PVC plumbing fittings, filters and others. The connectors can be, for example, crimp fittings, compression fittings, field attachable fittings, swivel fittings, access fittings, flare and flareless fittings, luer type fittings or hose barb fittings.

Many industries use connectors and fittings in liquid handling systems, for example including irrigation, manufacturing, solar heating, automotive, water treatment, waste processing, marine, space, military, chromatography, food processing, pharmaceutical, medical, industrial dispensers and food and beverage.

The ultrasonic device typically comprises an ultrasonic acoustic sensor that is excited by an electronic signal. In a single transducer system, the excitation of the sensor is marked by a START pulse. A transmitted wave travels to the target and a reflected wave echoes back. The echo is marked with a STOP pulse. The difference in time between START and STOP time-of-flight, or the difference in signal level between the transmitted wave and the reflected wave, indicates the flow of medium and fluid identification.

In a dual transducer system, the transducers work in a pitch-and-catch fashion. A first transducer is excited with a START pulse and a second transducer receives the transmitted wave and generates STOP pulses. The differential in time-of-flight between the transmitted wave and the reflected wave, or the difference in signal level between the transmitted wave and the reflected wave, indicates the flow of medium and fluid identification.

In certain embodiments, the ultrasonic device is integrated into the connector so as to produce an acoustic signal that is directed in a transverse direction to the fluid conduit. The presence or absence of media in a connector will result in a signal level or time of flight difference detected by the ultrasonic device.

In certain embodiments, the present technology is directed to a connector and the manufacture of a connector comprising a body having a first end with a first opening and a second end having a second opening and a passageway extending therethrough. The first and second openings adapted to receive an end of a fluid conduit. The body of the connector has an integrated ultrasonic device adapted for detecting the presence or absence of media passing through the passageway.

In certain embodiments the present technology comprises three or more ends and openings having shared passageways.

In other embodiments, the body is adapted to receive a first conduit that sealably covers, in a fluid-tight connection, at least part of the first end and a second conduit that covers at least part of the second end such that a fluid can communicate from one conduit to the other.

In certain embodiments, the first and second ends have an inside diameter. The ends are adapted to receive conduits that sealably conform, in a fluid-tight connection, to the inside diameter of the first and second ends. This allows a fluid to communicate from one conduit to the other through the passageway.

In certain embodiments, the connector can be a valve. Valves have two main components, a body and a bonnet, although some valves do not have bonnets. The bonnet is typically used to control and connect the actuator to the body.

The connector fittings of the present technology can be of thermoplastic, fluoropolymer and other plastic materials (including for example polyvinylfluoride, polyvinylidene fluoride, polytetrafluoroethylene, polychlorotrifluoroethylene, perfluoroalkoxy polymer, fluorinated ethylene-propylene, polyethylenetetrafluoroethylene, polyethylenechlorotrifluoroethylene, perfluorinated elastomers, fluorocarbons, fluoroelastomers, and perfluoropolyethers), metals (including for example copper, brass, steel and stainless steel) or any combination of those.

### DESCRIPTION OF THE DRAWINGS

FIG. 1 is a block diagram of an example of an ultrasonic device used with the disclosed technology.

FIG. 2 is a block diagram of an example of a system used with the disclosed technology.

FIG. 3 is an illustration of an embodiment of the disclosed technology.

FIG. 4 is a cross sectional view of an embodiment of the disclosed technology.

FIG. 5 is a cross sectional view of an embodiment of the disclosed technology.

FIG. 6 is an isometric view of an embodiment of the disclosed technology.

FIG. 7a is an isometric view of an embodiment of the disclosed technology.

FIG. 7b is a cross sectional view of the embodiment shown in FIG. 7a.

FIG. 8 is an isometric view of an embodiment of the disclosed technology.

FIG. 9 is a partially exploded isometric view of an embodiment of the disclosed technology.

FIG. 10 is a cross sectional view of an embodiment of the disclosed technology.

### DETAILED DESCRIPTION

As used herein, “fluid” means any state of matter in which component particles can move past one another; and includes any gases, liquids, fluidized solids, or slurries.

As used herein, “fitting” means any connector or an article that attaches a fluid conduit to another fluid conduit.

A fluid conduit can be a tube, pipe, hose, line, cannula, catheter, duct, drain or any other hollow form having two opened ends that allows for the passage of a fluid.

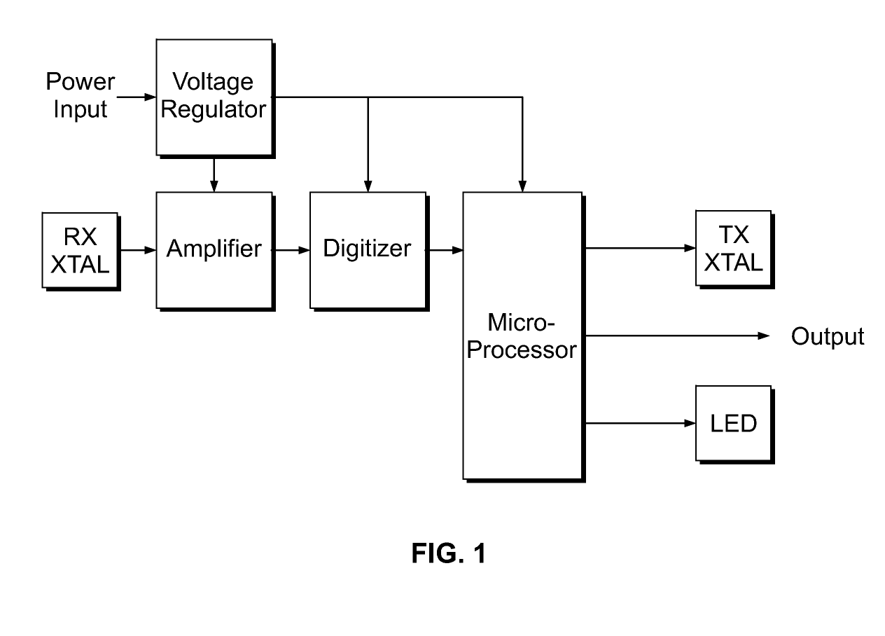

FIG. 1 is a block diagram of an ultrasonic device as used in certain embodiments of the present technology. The device can comprise, for example, a voltage regulator, amplifier, digitizer, microprocessor, piezoelectric transmitting crystal and an LED.

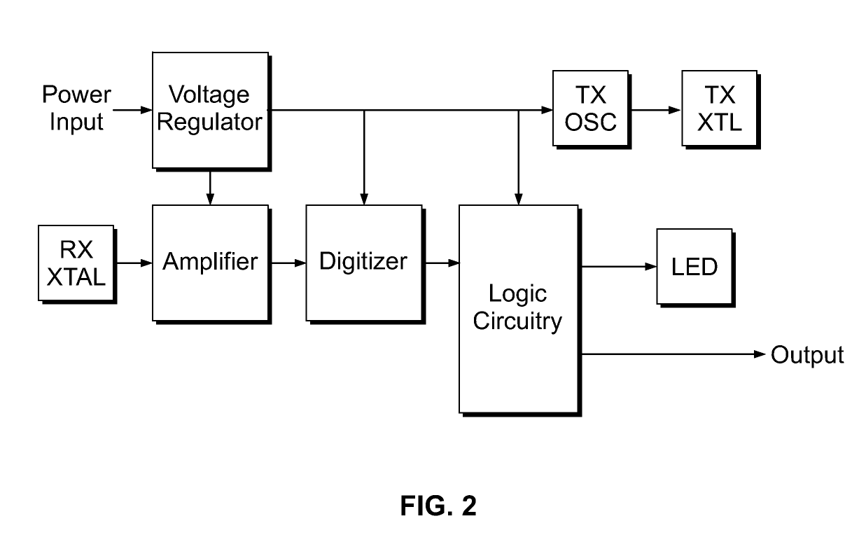

FIG. 2 is a block diagram of an ultrasonic device as used in the present technology. The device comprises a voltage regulator, amplifier, digitizer, a transmitting oscillator, logical circuits, a receiving piezoelectric crystal and a receiving crystal.

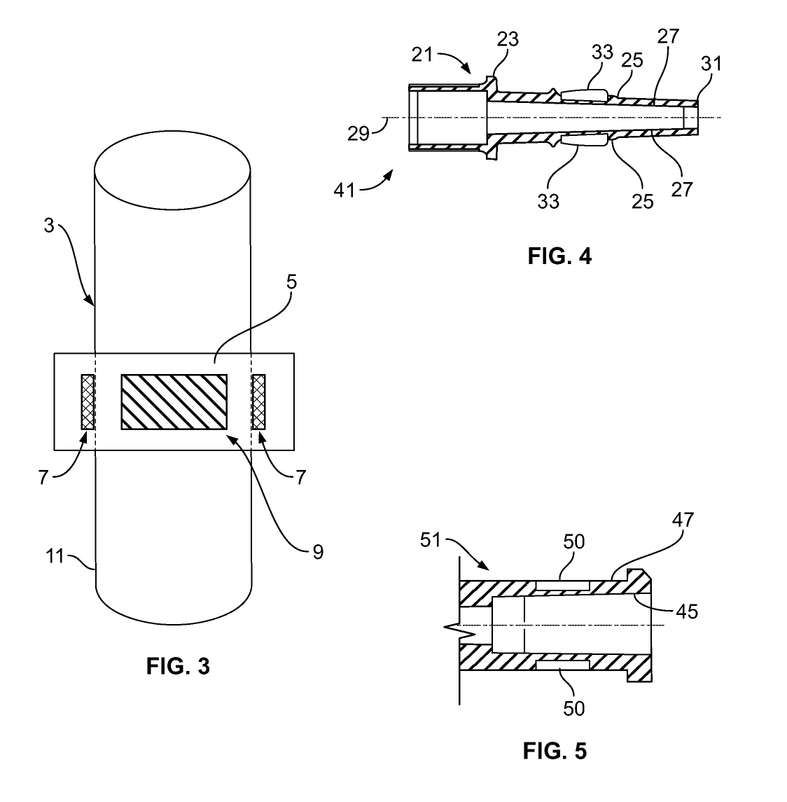

In certain embodiments of the present technology, for example, as shown in FIG. 3, a first fluid conduit 3 is sealably fixed to a connector 5 in a fluid-tight connection. The connector 5 has an integrated ultrasonic device comprising a piezoelectric crystal 7 fixed to the connector 5 and an electronic circuit 9. The connector 5 provides for fluid communication between the first fluid conduit 3 and a second fluid conduit 11.

FIG. 4 depicts certain embodiments of the present technology in the form of a male luer lock. Male and female luer fittings can be conventionally employed to connect disposable medical devices (including, but not limited to, a syringe and a needle) in a liquid and air leak-proof manner. After they have been connected, typically by pushing together by hand, luer taper fittings remain together due to friction between their mating tapered surfaces. They can be disconnected by twisting and pulling the female and male fittings away from each other.

There are many variations of luer style fittings, all of which can incorporate various aspects of the present technology. FIG. 4 shows, as a non-limiting example, a cross section of a luer male fitting 41 that comprises a nozzle 21, a ridge 23, an outer surface 25 and an inner surface 27. Nozzle 21 has a generally tapered cylindrical shape, with a central longitudinal axis 29 and a passageway defined by the inner surface 27. Tip 31 of nozzle 21 can have a thin profile (i.e., a reduced sidewall thickness) such that nozzle 21 may puncture a bag port membrane. An ultrasonic transducer 33 is fixed in the nozzle between the outer surface 25 and the inner surface 27.

Another embodiment of the present technology is an example of the female luer lock fitting shown in cross section in FIG. 5. In the embodiment shown therein, a fitting 51 comprises an inner surface 45, and an outer surface 47. The inner surface 45 corresponds to (that is, it is configured to couple with) an outer surface of a male fitting (for example, that shown in FIG. 4). The male fitting maintains a passageway, and the female fitting may comprise the fixed ultrasonic transducer 50.

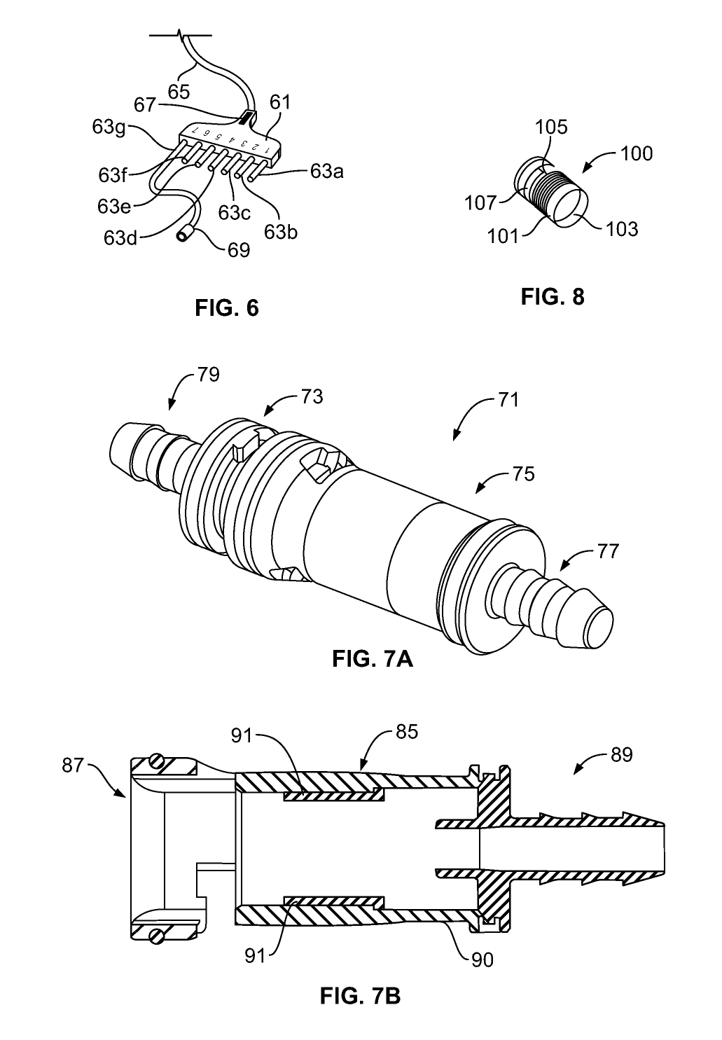

In another embodiment, an ultrasonic fitting 61 in FIG. 6 comprises a multi-lumen male portion—that is, a male portion with a plurality of lumens 63a-g. A single fluid conduit 65 transmits a fluid sample into the multi-lumen portion 63 which then transmits the fluid sample into several (in the embodiment shown in FIG. 6, seven) separated paths. A separate fluid conduit can be fixed to each of the male portions or lumens 63a-g as show by example with fluid conduit 69. This embodiment of the present technology comprises a fixed ultrasonic device 67 at the input end of the fluid into the fitting 61. Alternatively, a separate device may be fixed at the outputs of the device at each male portion or lumen 63a-g.

FIG. 7a shows an embodiment of an ultrasonic fitting 71. This fitting can be configured to fluidly couple conduits to any other appropriate fluid conduit, and readily connect and disconnect conduits to and from any other appropriate fluid conduit. Ultrasonic fitting 71 comprises an insert portion 73 and a holding portion 75. Insert portion 73 can be configured to engage with holding portion 75 to form a fluid-tight connection and may be configured to disengage with holding portion 75 to break the fluid-tight connection. Insert portion 73 comprises a connection end 79 and holding portion 75 can include a connection end 77. Connection ends 77, 79 are configured to connect insert portion 73 and holding portion 75 to suitable fluid conduits in fluid-tight arrangements.

In certain embodiments, connection ends 77, 79 can include a barbed surface configured to connect to a fluid conduit via an interference fit arrangement. Connection ends 77, 79 can also include any other suitable configuration to connect insert portion 73 and holding portion 75 to suitable fluid conduits in fluid-tight arrangements. For example, connection ends can include a threaded arrangement configured to engage corresponding grooves of a fluid conduit.

FIG. 7b is a cross-sectional view of the holding portion of another embodiment of the technology shown in FIG. 7a. Housing 85 can include a receiving end 87 opposite connection end 89, and may define a channel 90 configured to direct fluid therethrough. Housing 85 can also include a fixed ultrasonic device 91. As a fluid flows through the channel 90, it is able to detect air or other matter within the fluid stream.

In an embodiment as shown in FIG. 8, a fitting 100 comprises an outer surface 101 and an inner surface 103. Located on the outer surface are one or more barbs 105 that extend slightly beyond the diameter of the outer surface. Another variation of the fitting has a threaded end that allows the fitting to be threadedly engaged to a fluid conduit. The fitting receives the fluid conduit such that there is engagement between the inner surface of the conduit and the one or more barbs 105. An ultrasonic device 107 can be integrated into the fitting in a fixed manner such that fluid or air can be detected as it flows through the connector.

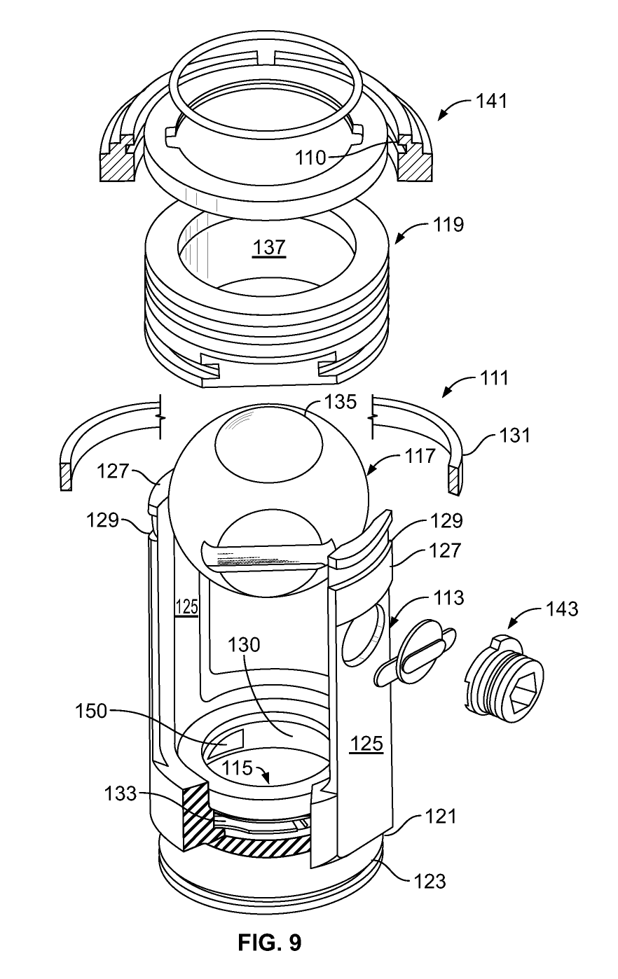

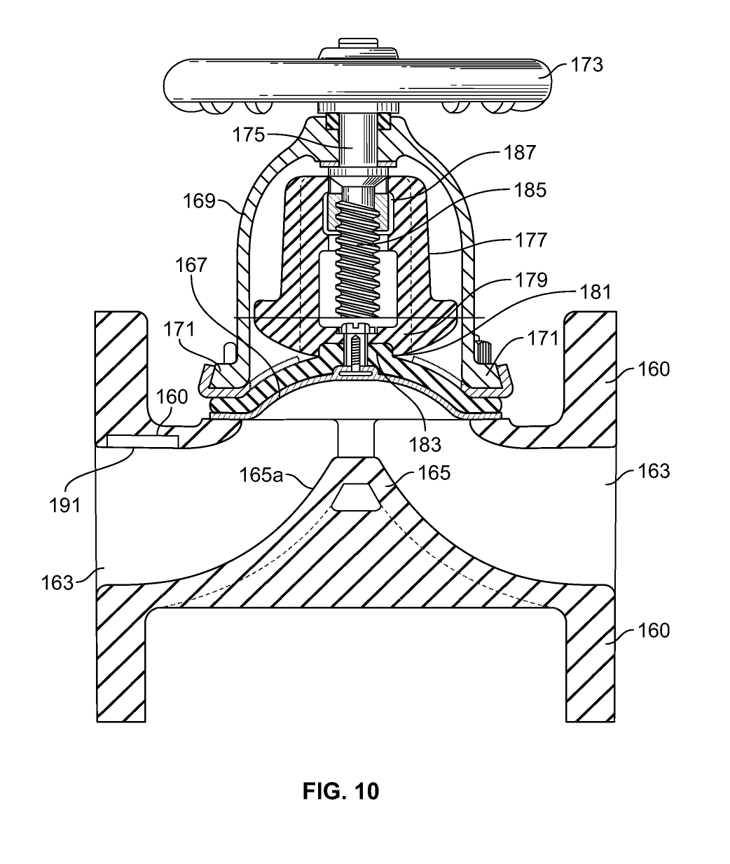

In certain embodiments as shown in FIG. 9, a kelly valve 110 comprises a housing (not shown), that includes a valve mechanism 111 comprising, as major components, a cage or carrier 113, a lower seat assembly 115, a floating valve ball 117 and an upper seat assembly 119. The valve mechanism 111 is positioned and held in the housing. An actuator cooperates with the valve ball 117 for positioning the valve ball 117 in open and closed positions, sealing against the upper and lower seat assemblies 115, 119.

The cage or carrier 113 provides a lower end 121 sized to be closely received in an intermediate recess. One or more lip type seals 123, such as for example polyseals, fit in a groove provided by the lower cage end 121. The seal 123 allows pressure leakage from below and seals against pressure from above.

A pair of ears 125 extend upwardly from the lower cage end 121 and terminate in enlarged ends 127 providing a groove 129. A split ring band 131 in the groove 129 holds the upper seal assembly 119 in position on top of the valve ball 117.

The lower seat assembly 115 rests on top of the wave spring 133 and provides an external groove receiving a second lip type polyseal allowing pressure leakage from below but sealing in response to pressure from above against the inside of the cage 113. The upper end of the lower seat assembly 115 provides an inclined surface providing a conventional O-ring sealing against pressure from either direction. The lower seat assembly 115 provides a central passage 130 for allowing the flow of fluid therethrough.

The valve ball 117 has a central passage 135 and a smooth exterior sealing surface. The upper seat assembly 119 provides an inner passage 137 and an inclined surface having an O-ring seal sealing against the exterior of the valve ball 117.

The valve mechanism 111 is retained in the housing by the locking assembly 141 which comprises a plurality of ring segments received in the recess. The valve ball 117 is turned by the actuator 143.

In the embodiment shown in FIG. 9, the ultrasonic device 150 is fixed along the wall of the central passageway 130 to provide detection of media in the fitting. As stated, the media can be one or more contaminants in the fluid that is flowing through the fitting, for example, air, water, or other gases or fluids.

In certain embodiments as shown, for example, in cross-section FIG. 10, a diaphragm valve comprises a body 160 having an inner passage 163 therethrough. The inner passage 163 is intersected by a shallow weir 165 whose top surface 165a is partially or fully concave and forms a seat across the inner passage for a diaphragm 167. The bonnet 169 can have any or all of the following: an annular flange 171, a handwheel 173, a valve spindle 175, and a compressor 177. The compressor 177 can include a central bottom portion 179, and a recess 181 to receive the hub 183.

In certain embodiments, the spindle 175 has a threaded portion 185 that engages a nut 187 held against rotation in the compressor 177. Upon rotation of the handwheel 173 in one direction, the spindle 175 is rotated and since the nut 187 and compressor 177 are prevented from rotating, both are moved downward toward the valve body 160 to seat the diaphragm 183 on the weir 165. This prevents the flow of fluid through the inner passage 163. Upon opposite rotation of the handwheel 173 the nut 187, compressor 177, and diaphragm 183 can be moved away from the weir 165.

In certain embodiments, an ultrasonic device 191 is fixed in the valve body 160 along the wall of the inner passageway 163 to provide detection of media in the fitting. The media can be contaminants in the fluid that is flowing through the fitting, for example, air, water, or other gases or fluids.

Ultrasonic devices are typically transceivers because they transmit and receive the sound waves. They then convert the sound waves into electrical signals that are then processed to evaluate attributes of the target sample. However, in certain embodiments, the present technology can also comprise separate transmitters and receivers. A typical ultrasonic device generates high-frequency sound waves in short pulses from piezoelectric type transmitters, but magnetostriction or other materials may be used. The device transmits the sound waves at a target sample and typically evaluates the echo that is received back by the sensor, measuring the time interval between sending the signal and receiving the echo to determine the distance to an object. In certain embodiments, of the current technology, the presence or absence of media in a connector will result in a signal level or time of flight difference detected by the ultrasonic device, i.e. air and a fluid will have different times of flight. Alternatively, the acoustic signal attenuation properties between air and fluid media can be used. In certain embodiments, the output from the ultrasonic device maybe hardwired to a display providing an analog output, logic output, digital bus output, LED or otherwise. It may also be wireless.

Typical wave frequency ranges between 1 MHz and 15 MHz or 1 Mhz to 3 Mhz. As the emitted waves propagate they are partially reflected or scattered by the target sample due to variations in acoustic impedance, pc. These variations are caused by density changes at the target. The characteristics of the reflective waves depend on the size of the sample feature and the wavelength of the emitted sound. Since the scattered energy can become too small to be useful when the wavelength is too long relative to the sample features, typically the emitted wavelength is chosen to be smaller than the features of interest.

After the ultrasonic wave is transmitted, the ultrasonic transducer receives waves reflected off structures and density gradients. The difference in signal level between the transmitted wave and the reflected wave and/or the time-of-flight difference can be transmitted and analyzed by an analyzer such as a computer or CPU. The delay time between the transmitted and received signal is correlated to the distance of the reflection source, while the intensity of the received signal is correlated to the reflection sources acoustic impedance and size. For example, air bubbles in a fluid conduit are detected because the time of flight for the ultrasonic wave hitting an air bubble is shorter than if no bubbles were present and the intensity of the received wave can be correlated to something other than what is supposed to be present in the conduit.

Although the present technology has been described in relation to particular embodiments thereof, these embodiments and examples are merely exemplary and not intended to be limiting. Many other variations and modifications and other uses will become apparent to those skilled in the art. The present technology should, therefore, not be limited by the specific disclosure herein, and may be embodied in other forms not explicitly described here, without departing from the spirit thereof.

What is claimed is:

1. A fluid fitting comprising:
a body having a first end having a first opening and a second end having a second opening and a passageway extending therethrough, the first and second openings adapted to receive an end of a fluid conduit; and,
an ultrasonic device integrated into the body and adapted for detecting the presence or absence of media passing through the passageway.

2. The fluid fitting of claim 1, wherein the ultrasonic device is an ultrasonic acoustic sensor that is excited by an electronic signal.

3. The fluid fitting of claim 2, wherein the ultrasonic device is integrated into the fluid fitting in a manner so as to produce an acoustic signal that is directed in a transverse direction to the fluid conduit.

4. The fluid fitting of claim 1, wherein the ultrasonic device comprises a single transducer system.

5. The fluid fitting of claim 4, wherein the excitation of the sensor is marked by a START pulse, and the echo is marked with a STOP pulse.

6. The fluid fitting of claim 1, wherein the ultrasonic device comprises a dual transducer system.

7. A method of detecting the presence or absence of media passing through a fitting comprising:
integrating an ultrasonic device into a fluid fitting in a manner so as to produce an acoustic signal that is directed in a transverse direction to the fluid conduit.

8. The method of claim 7, wherein the ultrasonic device comprises a single transducer system.

9. The method of claim 8, wherein an excitation of the sensor is marked by a START pulse, an echo is marked with a STOP pulse; and the difference in time between START and STOP time-of-flight indicates the flow of medium and fluid identification.

10. The method of claim 7, wherein the ultrasonic device comprises a dual transducer system.

11. The method of claim 10, wherein the transducers work in a pitch-and-catch fashion, wherein the first transducer is excited with a START pulse and a second transducer receives the transmitted wave and generates STOP pulses; and the difference in time-of-flight between the transmitted wave and the reflected wave indicates the flow of medium and fluid identification.

12. A method of manufacturing a fluid fitting comprising:
making a body having a first end having a first opening and a second end having a second opening and a passageway extending therethrough, the first and second openings adapted to receive an end of a fluid conduit; and,
integrating an ultrasonic device into the body that is adapted for detecting the presence or absence of media passing through the passageway.
